(19) United States
(12) Patent Application Publication
(10) Pub. No.: US 2004/0234835 A1
(43) Pub. Date: Nov. 25, 2004

(54) Fuel cell with integrated sensor

(76) Inventors: Raimund Strobel, Ulm (DE); Stefan Merkl, Ulm (DE); Dominique Tasch, Neu-Ulm (DE); Dieter Grafl, Ulm (DE); Matthias Laske, Ulm (DE); Kai Lemke, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/636,939

(22) Filed: Aug. 7, 2003

(30) Foreign Application Priority Data
Aug. 8, 2002 (DE) 102 36 845.7

(51) Int. Cl. H01M 8/04; H01M 2/08

(52) U.S. Cl. 429/35; 429/34; 429/22; 429/23; 429/24

(57) ABSTRACT

Fuel cell in layer technology, wherein at least one layer is formed by a bipolar plate and wherein at least one sensor element which forms an interface with the bipolar plate is provided, wherein the sensor element is partially surrounded with a sealing enclosure which protects against compression and contains electrical connecting elements, as well as use of the above-mentioned fuel cell for setting up a temperature profile in a fuel cell system.

The present invention concerns a fuel cell constructed in layer technology, in which at least one of the layers is formed by a bipolar plate.

When constructing a fuel cell, it is known that the functional elements of the fuel cell can be arranged in layers one above the other. In this case the arrangement can be in repeating fashion such that several fuel cells are formed one above the other and a so-called fuel cell stack is produced.

With such fuel cells in layer technology, particularly with fuel cell stacks, the drawback that uneven heat distribution produced in them within the fuel cell system results in an impairment of performance thereof, frequently arises.

Furthermore, it is known from the state of the art that temperature sensors for laboratory measuring purposes can be used at certain points in laboratory arrangements of fuel cell stacks. A disadvantage of these arrangements is, however, that the temperature sensors used here are too cost-intensive, too large if they have sufficient stability, and too delicate if dimensions are small enough. Hence the temperature sensors used as known are not suitable for reasons of cost and design reasons for industrial mass production and with respect to elimination of the above-mentioned disadvantageous temperature distribution.

It is the object of the present invention to provide a fuel cell which makes it possible to detect a profile of temperature distribution in a fuel cell system containing the fuel cells according to the invention, and to use this temperature profile of the fuel cell system for selective temperature control. Here, the drawbacks mentioned in the state of the art are to be avoided, and in particular a solution is to be robust and cheap particularly with regard to industrial mass production, as well as versatile to use in the design of the technical structure of the fuel cell in layer technology.

Further, it is the object of the present invention to provide a use for a fuel cell according to the invention, which serves to eliminate the drawback mentioned in the state of the art.

These objects are achieved according to the invention by a fuel cell according to claim 1 as well as the use of a fuel cell of the invention according to claim 13.

Due to the fact that at least one sensor element which forms an interface with the bipolar plate is provided, there is provided a measuring device which in a position suitable for the basic design of a fuel cell in layer technology can detect important quantities such as temperature and/or gas pressure and/or gas concentration. Further, the sensor element can particularly be well incorporated into the bipolar plate.

The sensor element can by nature be a temperature sensor, but also a sensor for the identification of different kinds of gas, for determination of the gas concentration, and further a pressure and/or moisture sensor, or a sensor for determining the conductivity of the cooling water.

Due to the fact that the sensor element is partially surrounded with a sealing enclosure which protects against compression, the layered arrangement of the fuel cell can be produced by force-locking without the sensor being destroyed due to contact pressures. In addition to this effect of the enclosure as a compression limiting means or supporting layer, depending on the requirements of the arrangement the enclosure has a sealing action in relation to the reactands introduced into the fuel cell during operation of the latter.

Also surrounded by the enclosure are electrical connecting elements which are electrically connected to the sensor element and can be designed as a strip conductor. By these electrical connecting elements the sensor can be connected to control devices, with the result that the signal of the sensor can be derived from the fuel cell.

Due to the fact that one or more fuel cells according to the invention are used in a fuel cell system, it is practically possible to set up in the fuel cell system a temperature profile of at least some of all the fuel cells. In this case, use can be extended to the effect that the temperature profile is part of a control circuit which serves to control the temperature of all the fuel cells.

It should be noted that the present invention can be used for practically any designs of bipolar plates. For example, composite systems of two bipolar plates with space between them for cooling fluid are possible, but of course ordinary single plates can also be fitted with temperature sensors according to the invention.

Advantageous developments of the fuel cell in layer technology according to claim 1 are possible according to the subsidiary claims and are described below.

In order perhaps to improve the sealing effect of the enclosure or to achieve sealing independently of the enclosure, it is advantageous to provide a seal which goes beyond the sealing effect of the enclosure, this sealing against the enclosure, deformation limiting layer and other rigid parts being effected by elastomer.

A way of constructing the enclosure of the sensor element with connecting element which is particularly simple in structure and easy to make is to design the enclosure as an deformation limiting layer, so that the sensor element with connecting elements is laterally surrounded with the deformation limiting layer in such a way that together there is formed a layer which is easily applied to the bipolar plate, and held in position by force-locking, for example. The deformation limiting layer here carries the contact pressures particular over a wide surface area.

In an advantageous development, the sensor element is at least partially embedded in the bipolar plate. For example a recess in which the sensor element can be inserted is possible for this. The bipolar plate can in this case have, apart from the structures for holding the sensor element, additionally corresponding structures for the connecting elements to a measurement pick-up unit and/or the enclosure.

Advantageously, the structures of the bipolar plate or deformation limiting layer are to be designed in such a way that, in addition to the sensor element, the connecting elements are also protected against compression.

In a further advantageous development, a heat-conducting layer is applied on the side of the sensor element facing away from the bipolar plate. The thermal conductivity of this layer should in this case be so high that almost perfect temperature measurement on the corresponding component via this heat-conducting layer is made possible. For example, a heat-conducting paste can be applied as thermal conductivity. It is additionally preferred if the bipolar plate which faces towards the reaction zone has high thermal conductivity. Alternatively, or in addition, the above-mentioned deformation limiting layer can also be a protective layer against mechanical wear. Further simplifying the structure and hence the manufacturing process is an advantageous embodiment in which the enclosure and the heat-conducting layer are at least partially identical. Thus several functions are combined in one device element.

In addition, functions can be further combined and hence the structure advantageously simplified technically, if not only are the enclosure and heat-conducting layer at least partially identical, but also the heat-conducting layer is at the same time an elastomer used for sealing.

The preferred material for the bipolar plates is a selection or mixture of graphite, graphite composite and/or metal. The layer thickness of such a bipolar plate is advantageously between 50 μm and 10 mm.

A further advantageous development provides that the enclosure and/or above-mentioned deformation limiting layer are given an electrically insulating effect. Particularly in the event that the enclosure is designed as an deformation limiting layer, it is favourable to electrically insulate the deformation limiting layer at the end faces of the recess.

A particularly advantageous development of the invention provides that a thin-film sensor is used as the sensor element. As a result, the sensor function can be integrated in existing systems neutrally with respect to the thickness of installation, so that the expenditure on changing from ordinary fuel cells in layer technology to those which according to the invention contain a sensor element with enclosure and connecting elements, is minimal.

Advantageously, the sensor element can be constructed as a gas sensor for measuring the gas concentration and/or as a gas pressure sensor and/or as a moisture sensor, with the result that the state of the reactands occurring in the fuel cell can be determined. Advantageously, this temperature sensor can be a PTC resistor, a PT-100, PT-1000, NTC resistor or thermoelement.

An advantageous development of use of the fuel cell in a total fuel cell system according to the invention is to use the temperature profile set up in the use for control of the temperature, i.e. selective influencing of the temperature distribution in the fuel cell system, particularly in the fuel cell stack. Thus it is made possible, in connection with a cooling medium or cooling layer provided in the fuel cell, to regulate a cooling circuit as a function of the temperature distribution in the fuel cell stack.

The invention is described below with reference to practical examples. The figures show:

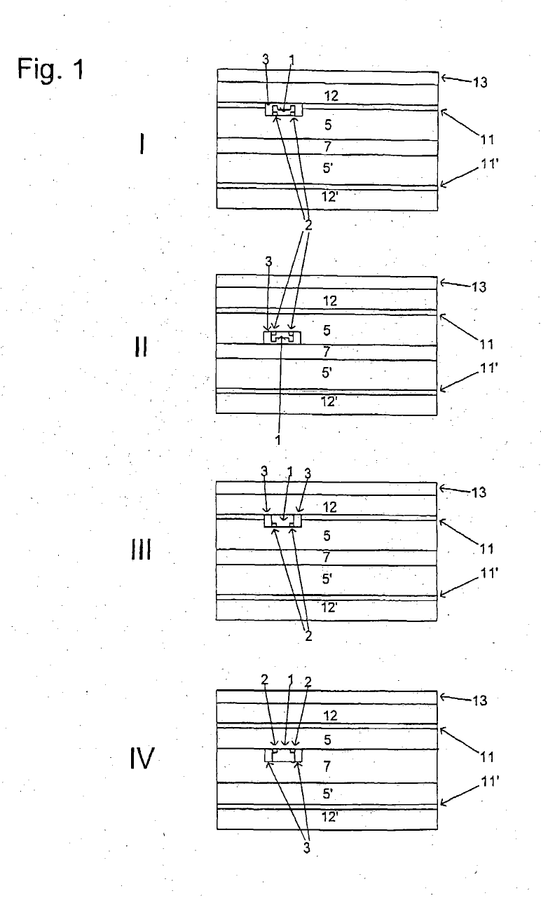

FIG. 1 the basic arrangement of a practical example of a sensor according to the invention in a fuel cell in layer technology, as a temperature, pressure, moisture and/or as a gas sensor in cross-section,

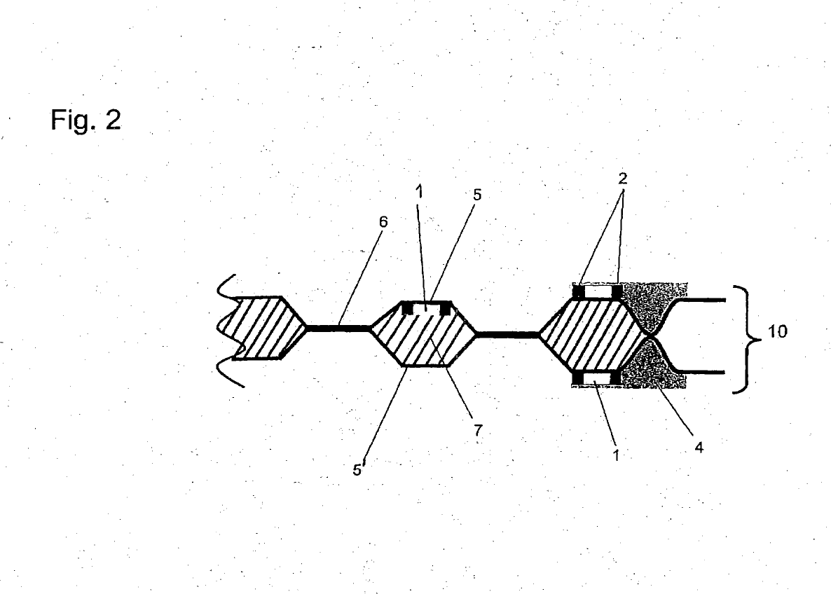

FIG. 2 a cross-section through a practical example of a fuel cell in which the bipolar plates are formed in such a way that coolant regions arise, and

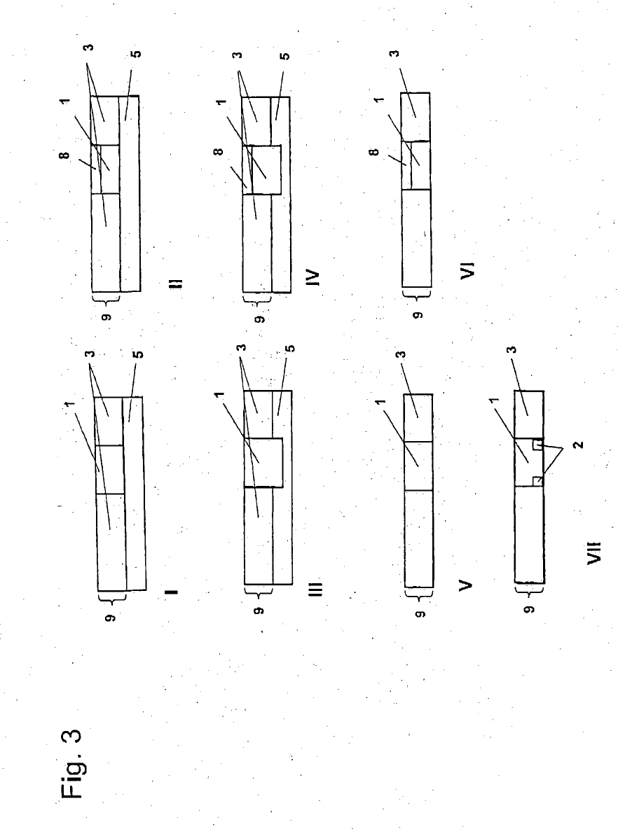

FIG. 3 seven variants of installation of the sensor in the layer system of a fuel cell in layer technology.

FIG. 1 shows the basic arrangement of a sensor in the layer system of a fuel cell in layer technology.

FIG. 1 I shows a layer composite of membrane and electrodes 13 and a gas diffusion region 12 for air and oxygen and a second gas diffusion region 12′ for the fuel, optional coatings 11 and 11′, and a first bipolar plate 5 and a second bipolar plate 5′ and a cooling layer 7 arranged between the bipolar plates.

This basic layer structure is the same in FIG. 1 I, FIG. 1 II and FIG. 1 III.

In this layer composite, in I, II and III respectively a sensor 1 with connecting elements 2 in the form of printed strip conductors and a protective coating 3 which surrounds the sensor and the printed strip conductor and which protects against compression and has a sealing effect, is positioned. The connecting elements 2 make an electrical connection from the sensor to the outside world. The sensor assemblies shown in this figure under I and II on the segment 1, connecting element 2 and enclosure 3 are in each case embedded completely or partially on the cathode side, on the anode side and/or in the cooling water. This involves construction of the sensor 1 as a temperature sensor. The lateral enclosure 3 for protection against compression and for sealing surrounds the sensor 1 laterally and also on the rear side, forming an interface with the gas diffusion region 12 in FIG. 1 I and forming an interface with the cooling layer 7 in FIG. 1 II.

In these examples, the structures incorporated into the bipolar plate 5 for embedding the sensor assembly consisting of sensor strip conductor and enclosure are shaped in such a way that printed strip conductors 2, sensor 1 and lateral enclosure 3 form a planar interface with the main surface of the fitting 5. Other structures are quite conceivable too.

The bipolar plates 5 and 5′ can be made of graphite, graphite composite and metal, or a mixture of them, and can have a thickness between 10 μm and 10 mm.

The optional coating 11 or 11′ can attain a thickness from 1 nm to 200 μm.

In FIG. 1 III is chosen an assembly such as is relevant to construction of the sensor 1 as a gas or gas pressure sensor and/or moisture sensor. Here the assembly consisting of sensor 1 and lateral enclosure 3 is modified from the examples shown in FIG. 1 I and FIG. 1 II. As in FIG. 1 I, here too the sensor assembly consisting of sensor 1, connecting element 2 and enclosure 3 forms an interface with the gas diffusion region 12. Unlike FIG. 1 I, however, here in FIG. 1 III the sensor 1 forms a direct interface with the gas diffusion layer 12. The enclosure 3 here serves above all as protection against compression.

In FIG. 1 IV is shown a sensor assembly consisting of sensor 1, connecting element 2 and enclosure 3 as is also shown in FIG. 1 III. In this view of FIG. 1 IV, however, the sensor assembly is located wholly in the cooling layer 7 and forms an interface with the bipolar plate 5. In this case the side of the sensor assembly on which the connecting elements 2, the sensor element 1 and the lateral enclosures 3 form a surface, forms an interface with the bipolar plate 5.

FIG. 2 shows a cross-section through a fuel cell with two shaped bipolar plates 5 and 5′, which are shaped in such a way that alternately the plates are connected at the locations 6 and form coolant regions 7 (shown hatched). The connections can be fixed to each other by soldering, gluing and/or welding. Adjoining the bipolar plate 5 on the anode side and bipolar plate 5′ on the cathode side, respectively, on the right on the sealing side are sensor elements 1, each laterally provided with connecting elements 2 designed as a strip conductor. The region 4 with grained base shows the sealing of the bipolar plates, the combination of which attains a total height 10 of between 20 μm and 20 mm.

The sensor element 1 of analogous structure with connecting elements 2 in the middle of the drawing is adjoining the bipolar plate 5 on the side of the coolant zone.

FIG. 3 shows in I to VII different variants for installation of the sensor 1 in the lateral enclosure of the sensor 3 with and without bipolar plate 5.

FIG. 3 I shows the enclosure elements which are constructed as an deformation limiting layer 3 and in the recess of which the sensor element 1 is embedded. At the same time this sensor layer 9 is applied to a bipolar plate 5. II shows, comparably to I, the application of a sensor layer 9 to a bipolar plate 5, the sensor element 1 only partially filling the recess, as on the side facing away from the bipolar plate in addition is applied a heat-conducting layer 8 which also or alternatively protects against mechanical damage.

FIG. 3 III shows the sensor element 1 constructed so as firstly to completely fill the recess of the deformation limiting layer 3 and at the same time extend into the bipolar plate 5. For this, the bipolar plate 5 has a structure in which the sensor element 1 is inserted. In this case a force-locking connection between bipolar plate 5 and sensor element 1 is not absolutely necessary. In IV, the sensor element 1 extends likewise into the bipolar plate 5, wherein here on the side of the sensor element facing away from the bipolar plate 5 is additionally applied a heat-conducting layer or layer 8 protecting against mechanical damage. This layer 8 can be applied e.g. in the form of a paste.

FIG. 3 V shows, similarly to FIG. 3 I, a sensor layer 9 consisting of a lateral enclosure 3 or deformation limiting layer 3, in the recess of which is introduced a sensor element 1. In this case, however, no bipolar plate is provided. VI shows, corresponding to V, a sensor layer 9 consisting of an deformation limiting layer 3, in the recess of which is fixed a sensor element 1 which is covered on one side with a heat-conducting layer or layer 8 protecting against mechanical damage.

FIG. 3 VII shows a sensor layer 9, consisting of an enclosure 3 surrounding the sensor 1 on both sides as in all the other examples of this FIG. 3, or deformation limiting layer 3, wherein here connecting elements 2 in the form of printed strip conductors are incorporated into the sensor element 1 or the sensor element 1 is structured in such a way that the connecting elements 2 can be embedded therein so that the surface of the sensor layer 9 on the strip conductor side is planar.

1. Fuel cell in layer technology, wherein at least one layer is formed by a bipolar plate, characterised in that at least one sensor element (1) which forms an interface with the bipolar plate (5, 5′) is provided, wherein the sensor element is partially surrounded with a sealing enclosure (3) which protects against compression and contains electrical connecting elements (2) for electrical connection capacity to control devices.

2. Fuel cell according to claim 1, characterised in that the enclosure (3) is constructed as an deformation limiting layer and the sensor element (1) with connecting elements (4) and deformation limiting layer together form a layer (9) which is applied to the bipolar plate (5, 5′).

3. Fuel cell according to either of claims 1 or 2, characterised in that in the bipolar plate (5, 5′) on the side facing towards the sensor element (1) are embedded structures into which extend the sensor element (1) and/or the connecting elements (2) and/or the enclosure (3).

4. Fuel cell according to any of claims 1 to 3, characterised in that a heat-conducting layer is applied on the side of the sensor element (4, 4′) facing away from the bipolar plate (5, 5′).

5. Fuel cell according to claim 4, characterised in that the enclosure and the heat-conducting layer are identical.

6. Fuel cell according to any of claims 1 to 5, characterised in that the bipolar plate (5, 5′) is made of graphite, graphite composite and/or metal.

7. Fuel cell according to any of claims 1 to 6, characterised in that the bipolar plate (5, 5′) has a layer thickness from 50 μm to 10 mm.

8. Fuel cell according to any of claims 1 to 7, characterised in that the enclosure has an electrically insulating effect.

9. Fuel cell according to any of claims 1 to 8, characterised in that the sensor element is a thin-film sensor.

10. Fuel cell according to any of claims 1 to 9, characterised in that the sensor element is a gas sensor and/or pressure sensor and/or moisture sensor.

11. Fuel cell according to any of claims 1 to 10, characterised in that the sensor element is a temperature sensor.

12. Fuel cell according to claim 11, characterised in that the temperature sensor element is a PTC resistor, a PT-100, PT-1000, NTC or a thermoelement.

13. Use of at least one fuel cell according to any of claims 1 to 12 in a fuel cell system for setting up a temperature profile.

14. Use according to claim 13 for control of the temperature of the fuel cell system.
